(19) United States
(12) Patent Application Publication
(10) Pub. No.: US 2010/0307599 A1
(43) Pub. Date: Dec. 9, 2010

(54) FLUID DEVICE WITH MAGNETIC LATCHING VALVES

(76) Inventors: Benjamin James Morris, Ann Arbor, MI (US); Jeffrey Charles Thompson, Commerce Township, MI (US)

Correspondence Address: MERCHANT & GOULD PC, P.O. BOX 2903, MINNEAPOLIS, MN, 55402-0903, US

(21) Appl. No.: 12/793,569

(22) Filed: Jun. 3, 2010

Related U.S. Application Data
(60) Provisional application No. 61/183,714, filed on Jun. 3, 2009.

(51) Int. Cl. F16K 31/08

(52) U.S. Cl. 137/2; 251/65

(57) ABSTRACT

A method of valving a fluid device includes receiving a signal that is correlated to a displacement of a volume chamber of a displacement assembly of a fluid device. A check ball is delatched from a magnetic pole of a first latch valve that is in fluid communication with the volume chamber and a fluid inlet of the fluid device when the displacement of the volume chamber reaches a first value. A check ball is delatched from a magnetic pole of a second latch valve that is in fluid communication with the volume chamber and a fluid outlet of the fluid device when the displacement of the volume chamber reaches a second value.

### CROSS REFERENCE TO RELATED APPLICATION

The present disclosure claims priority to U.S. Provisional Patent Application No. 61/183,714 entitled “Magnetic Latching Check Valve” and filed on Jun. 3, 2009, which is hereby incorporated by reference in its entirety.

### BACKGROUND

Fluid pumps and motors are used in various off-highway and on-highway applications. Typical off-highway and on-highway applications include construction and agriculture equipment such as skidsteer loaders, backhoes, combines, etc. Fluid pumps and motors can be used for propel and/or work functions.

### SUMMARY

An aspect of the present disclosure relates to a method of valving a fluid device. The method includes receiving a signal that is correlated to a displacement of a volume chamber of a displacement assembly of a fluid device. A check ball is delatched from a magnetic pole of a first latch valve that is in fluid communication with the volume chamber and a fluid inlet of the fluid device when the displacement of the volume chamber reaches a first value. A check ball is delatched from a magnetic pole of a second latch valve that is in fluid communication with the volume chamber and a fluid outlet of the fluid device when the displacement of the volume chamber reaches a second value.

Another aspect of the present disclosure relates to a method of valving a fluid device. The method includes receiving a signal. The signal is correlated to a position of a piston in a cylinder bore of a fluid device. An electronic pulse is transmitted to a coil of a first latch valve when the piston reaches a first position in the cylinder bore. The first latch valve is in fluid communication with a fluid inlet and a volume chamber defined by the piston and the cylinder bore. The electronic pulse delatches a check ball from a magnetic pole of the first latch valve. An electronic pulse is transmitted to a coil of a second latch valve when the piston reaches a second position in the cylinder bore. The second latch valve is in fluid communication with a fluid outlet and the volume chamber. The electronic pulse delatches a check ball from a magnetic pole of the second latch valve.

Another aspect of the present disclosure relates to a fluid device. The fluid device includes a housing defining a fluid inlet and a fluid outlet. A displacement assembly is in fluid communication with the fluid inlet and the fluid outlet. The displacement assembly defines a plurality of volume chambers. A plurality of first magnetic latch valves is in fluid communication with the fluid inlet and the plurality of volume chambers. A plurality of second magnetic latch valves is in fluid communication with the fluid outlet and the plurality of volume chambers. Each of the first and second magnetic latch valves includes a body defining a cavity having a valve seat. A coil is disposed in the cavity. A permanent magnet is disposed in the cavity. A magnetic pole has a first end portion and an oppositely disposed second end portion. The first end portion is adjacent to the permanent magnet. A check ball is disposed in the cavity between the second end portion of the magnetic pole and the valve seat.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a schematic representation of an actuator system.

FIG. 2 is a schematic representation of an alternate embodiment of an actuator system.

FIG. 3 is a schematic representation of a fluid device having exemplary features of aspects in accordance with the principles of the present disclosure.

FIG. 4 is an isometric view of a latch valve suitable for use with the fluid device of FIG. 3.

FIG. 5 is an isometric view of the latch valve of FIG. 4.

FIG. 6 is a cross-sectional view of the latch valve of FIG. 4.

FIG. 7 is schematic representation of first and second latch valves in fluid communication with a volume chamber when the fluid device is in pumping mode.

FIG. 8 is a schematic representation of a filling/emptying cycle of the volume chamber when the fluid device is in pumping mode.

FIG. 9 is a schematic representation of first and second latch valves in fluid communication with the volume chamber when the fluid device is in motoring mode.

FIG. 10 is a schematic representation of a filling/emptying cycle of the volume chamber when the fluid device is in motoring mode.

FIG. 11 is a representation of a method for valving the fluid device.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

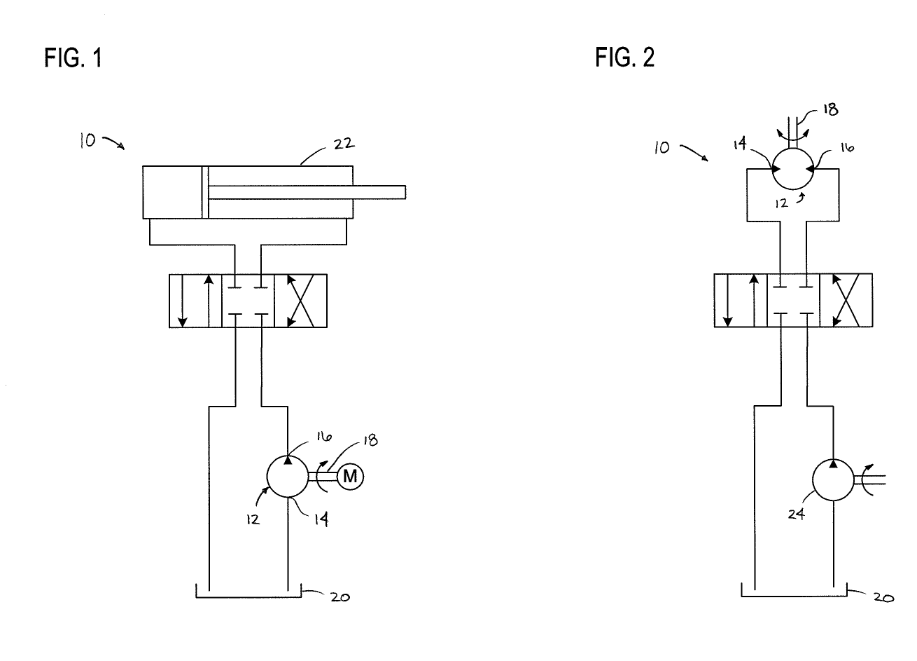

Referring now to FIGS. 1 and 2, an actuator system 10 is shown. The actuator system 10 includes a fluid device 12. The fluid device 12 includes a fluid inlet 14, a fluid outlet 16 and a shaft 18. The fluid device 12 can operate as a fluid pump or a fluid motor. When the fluid device 12 is operated as a fluid pump (shown in FIG. 1), the shaft 18 is coupled to a power source M (e.g., engine, motor, electric motor, etc.) so that the shaft 18 rotates. As the shaft 18 rotates, fluid is pumped from the fluid inlet 14 of the fluid device 12 to the fluid outlet 16. In the depicted embodiment of FIG. 1, the fluid inlet 14 is in fluid communication with a fluid reservoir 20 while the fluid outlet 16 is in fluid communication with an actuator 22.

When the fluid device 12 is operated as a fluid motor (shown in FIG. 2), pressurized fluid is communicated to the fluid inlet 14 by a pump 24 while fluid from the fluid outlet 16 is communicated to the fluid reservoir 20. The shaft 18 rotates in response to the pressurized fluid passing through the fluid device 12.

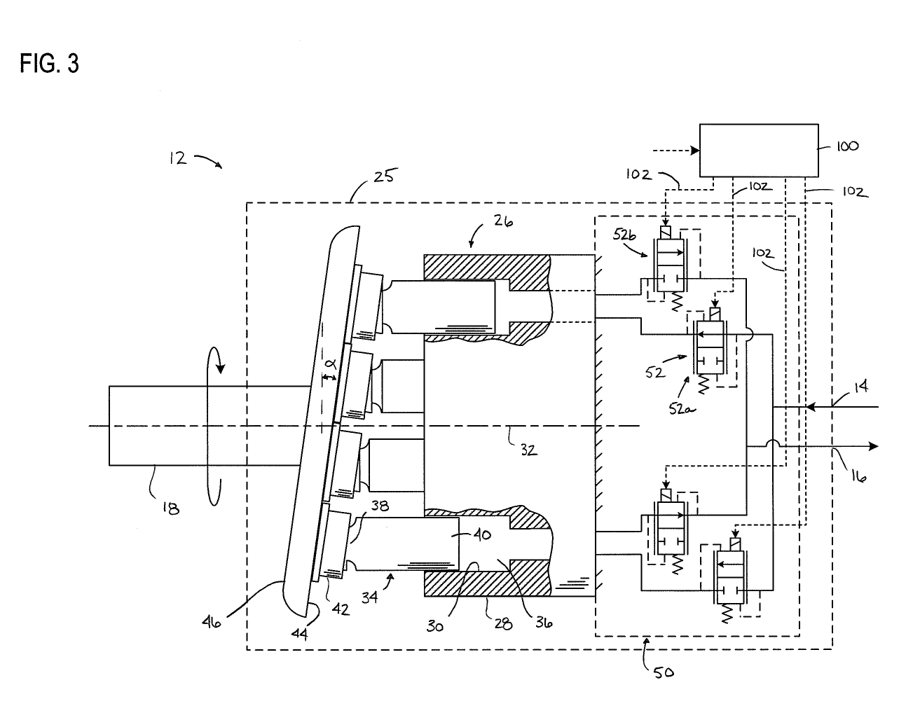

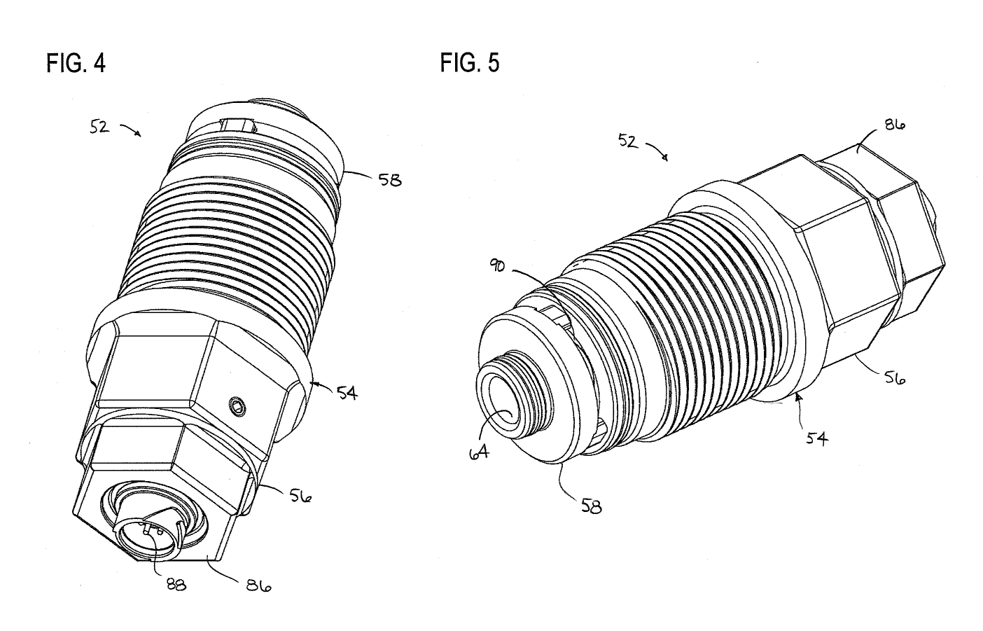

Referring now to FIG. 3, an embodiment of the fluid device 12 is shown. The fluid device 12 includes a housing 25 defining the fluid inlet 14 and the fluid outlet 16. The fluid device 12 includes a displacement assembly 26 that is in fluid communication with the fluid inlet 14 and the fluid outlet 16. In the depicted embodiment, of FIG. 3, the displacement assembly 26 is an axial piston assembly. In other embodiments, the displacement assembly 26 can be a rotary piston assembly, a vane assembly, a gerotor assembly, a cam lobe assembly, etc.

In the depicted embodiment, the displacement assembly 26 includes a cylinder barrel 28. The cylinder barrel 28 defines a plurality of cylinder bores 30. In one embodiment, the cylinder barrel 28 defines six cylinder bores 30. In another embodiment, the cylinder barrel 28 defines less than or equal to twelve cylinder bores 30. The cylinder bores 30 are symmetrically arranged about a central axis 32 of the cylinder barrel 38.

A plurality of pistons 34 is disposed in the plurality of cylinder bores 30. The pistons 34 are adapted for reciprocating motion in the cylinder bores 30. The plurality of pistons 34 and the plurality of cylinder bores 30 cooperatively define a plurality of volume chambers 36. The volume chambers 36 are adapted to expand and contract.

Each of the pistons 34 includes a first axial end 38 and an oppositely disposed second axial end 40. The first axial end 38 includes a slipper 42. The slipper 42 is adapted for sliding engagement with a surface 44 of a swash plate 46. The swash plate 46 defines a stroke angle a. As the stroke angle a increases, the amount of fluid displaced through the displacement assembly 26 increases.

In the depicted embodiment, the swash plate 46 is engaged with the shaft 18 of the fluid device 12. The engagement between the swash plate 46 and the shaft 18 is such that the swash plate 46 rotates in unison with the shaft 18. In the depicted embodiment, the cylinder barrel 28 is rotationally stationary. As the shaft 18 and swash plate 46 rotate about the central axis 32, the pistons 34 reciprocate in the cylinder bores 32. In other embodiments, the cylinder barrel 28 rotates with the shaft 18 while the swash plate 46 remains rotationally stationary.

The displacement assembly 26 is in fluid communication with the fluid inlet and outlet 16, 16 through a valve assembly 50. The valve assembly 50 includes a plurality of latch valves 52. Each volume chamber 36 of the displacement assembly 26 is in selective fluid communication with the fluid inlet 14 through a first latch valve 52a and in selective fluid communication with the fluid outlet 16 through a second latch valve 52b. In the depicted embodiment, the first and second latch valves 52a, 52b are substantially similar in structure.

Referring now to FIGS. 4-6, the latch valve 52 is shown. As the first and second latch valves 52a, 52b are substantially similar in structure, the first and second latch valves 52a, 52b will be described as the latch valve 52 for ease of description purposes only. As the first and second latch valves 52a, 52b are substantially similar in structure, the structures of the first and second latch valves 52a, 52b will have the same reference numerals as the structure of the latch valve 52 except that the reference numerals for the structure of the first latch valve 52a will include an “a” at the end of the reference numeral while the structure of the second latch valve 52b will includes a “b” at the end of the reference numeral.

The latch valve 52 includes a body 54. The body 54 includes a first axial end portion 56 and an oppositely disposed second axial end portion 58. The body 54 defines a cavity 60 that extends through the first and second axial end portions 56, 58. The cavity 60 includes a first end 62 disposed at the first axial end portion 56 of the body 54 and an oppositely disposed second end 64 disposed at the second axial end portion 58 of the body 54. The cavity 60 further includes a valve seat 66 disposed at between the first and second ends 62, 64 of the cavity 60.

The latch valve 52 further includes a permanent magnet 68 and a magnetic pole 70 disposed between the first end 62 of the cavity 60 and the valve seat 66. The magnetic pole 70 includes a first end portion 72 and an oppositely disposed second end portion 74. In the subject embodiment, the permanent magnet 68 is disposed adjacent to the first end portion 72 of the magnetic pole 70. In the depicted embodiment, the permanent magnet 68 is disposed immediately adjacent to the first end portion 72 of the magnetic pole 70.

A sleeve 76 is disposed in the cavity 60 of the body 54. The sleeve 76 is made of a non-magnetic material and defines a bore 78 that extends axially through the sleeve 76. The magnetic pole 70 is disposed in the bore 78 of the sleeve 76. In the depicted embodiment, a coil 80 is disposed about the sleeve 76.

The latch valve 52 further includes a flux ring 82, which is axially disposed in the cavity 60 between the coil 80 and the permanent magnet 68, and a spacer 84 disposed adjacent to the flux ring 82. In the depicted embodiment, the spacer 84 is made of a non-magnetic material.

A cap 86 is adapted for engagement with the first axial end portion 56 of the body 54. The cap 86 includes a plurality of external threads that is adapted for engagement with internal threads disposed in the cavity 60. The cap 86 further includes a connector 88 that is in electrical communication with the coil 80.

The second axial end portion 58 of the body 54 defines a passage 90 that extends through an exterior surface 92 of the body 54 to the cavity 60. An opening 94 to the passage 90 at the cavity 60 is disposed between the first end 62 and the valve seat 66.

A check ball 96 is disposed in the cavity 60 of the latch valve 52. The check ball 96 is made of a magnetic material and is spherical in shape. The check ball 96 is adapted for sealing engagement with the valve seat 66. The check ball 96 is disposed between the valve seat 66 and the second end portion 74 of the magnetic pole 70. In the depicted embodiment, a spring 98 biases the check ball 96 into engagement with the valve seat 66. The check ball 96 is adapted to selectively block or provide fluid communication between the passage 90 and the second end 64 of the cavity 60.

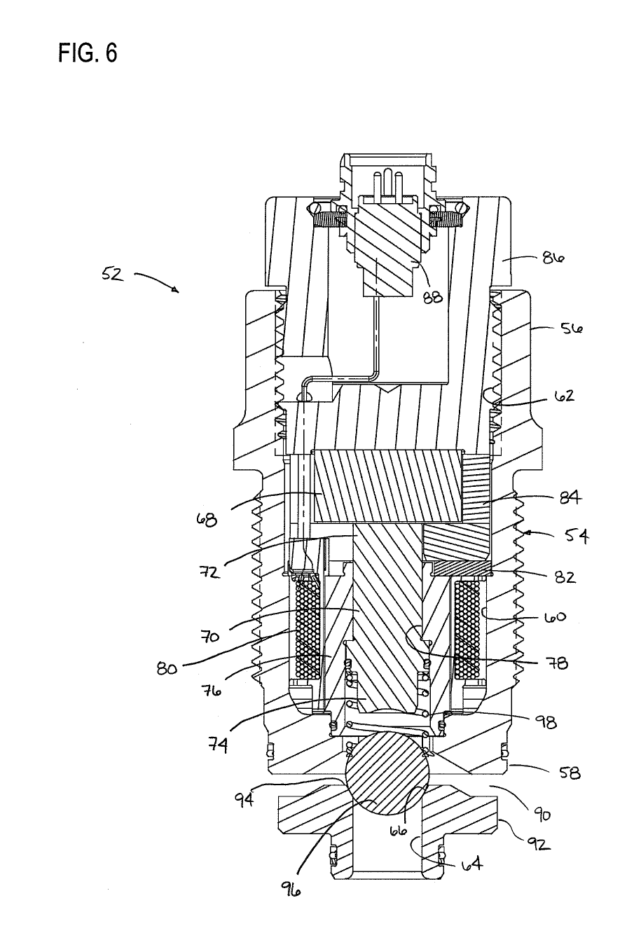

Referring now to FIGS. 3 and 6, the operation of the latch valve 52 will be described. The check ball 96 is biased toward a closed position, in which the check ball 96 is engaged with the valve seat 66, by the spring 98. With the check ball 96 abutting the valve seat 66, fluid communication between the second end 64 of the cavity 60 and the passage 90 is blocked.

When fluid pressure (P2) at the second end 64 of the cavity 60 increases to a value that is greater than the fluid pressure (P1) at the passage 90 and the force of the spring 98 acting on the check ball 96, the check ball 96 is pushed off the valve seat 66 to an open position. In the depicted embodiment, the check ball 96 is pushed off the valve seat 66 in a direction toward the second end portion 74 of the magnetic pole 70. When the check ball 96 touches the second end portion 74 of the magnetic pole 70, the check ball 96 is held in engagement (i.e., “latched”) with the second end portion 74 of the magnetic pole 70 by the permanent magnet 68 regardless of the difference between the fluid pressure (P2) at the second end 64 of the cavity 60 and the fluid pressure (P1) at the passage 90. In one embodiment, the magnetic force of the permanent magnet 68 is sufficient to overcome the force of the spring 98 and the flow forces of the fluid passing through the passage 90 and the second end 64 of the cavity 60.

To release the check ball 96 from the magnetic field of the permanent magnet 68 (i.e., “delatch”), a controller 100 (e.g., a central processing unit) sends an electronic signal 102 (e.g., an electrical current) having a first polarity to the coil 80. In one embodiment, the electronic signal 102 is an electronic pulse. In one embodiment, the coil 80 generates a first magnetic field in response to the electronic signal 102 that opposes the magnetic field of the permanent magnet 68 and reduces the magnetic force holding the check ball 96 to the magnetic pole 70. As the electronic signal 102 increases, the first magnetic field generated by the coil 80 increases. In one embodiment, the first magnetic field generated by the coil 80 is subtracted from the magnetic field of the permanent magnet 68 to form a first resultant magnetic field that acts on the check ball 96. As the first magnetic field of the coil 80 increases, the first resultant magnetic field decreases. With the magnetic field of the permanent magnet 68 reduced by the first magnetic field generated by the coil 80, the force of the spring 98 acting on the check ball 96 and fluid forces acting on the check ball 96 actuate the check ball 96 from the open position to the closed position, in which the check ball 96 abuts the valve seat 66.

The latch valve 52 is potentially advantageous as a result of the short duration of the electronic signal 102. As the electronic signal 102 is only required to release the check ball 96 from the magnetic pole 70, the power consumption of the latch valve 52 is less than a typical solenoid valve, which requires constant power to hold the valve in one position or another. This feature can potentially minimize parasitic actuation power losses.

In another embodiment, the controller 100 can be used to actuate the check ball 96 from the closed position to the open position. To actuate the check ball 96 to the open position, a second electronic signal having a second polarity, which is opposite the first polarity, is sent to the coil 80. In response to the second electrical signal, the coil 80 generates a second magnetic field. The second magnetic field is added to the magnetic field of the permanent magnet 68 to form a second resultant magnetic field that acts on the check ball 96. As the second magnetic field of the coil 80 increases, the second resultant magnetic field increases. As the second resultant magnetic field increases, the check ball 96 is lifted from the valve seat 66 to the second end portion 74 of the magnetic pole 70 regardless of the difference between the fluid pressure (P2) at the second end 64 of the cavity 60 and the fluid pressure (P1) at the passage 90.

Referring now to FIGS. 3 and 6-8, the operation of the fluid device 12 as a pump will be described. As previously provided, each volume chamber 36 is in selective fluid communication with the fluid inlet 14 through the first latch valve 52a and the fluid outlet 16 through the second latch valve 52b. Each of the first and second latch valves 52a, 52b is mechanically (e.g., hydraulically) actuated to the open position and latched in the open position, electronically delatched, and mechanically (e.g., hydraulically) actuated to the closed position.

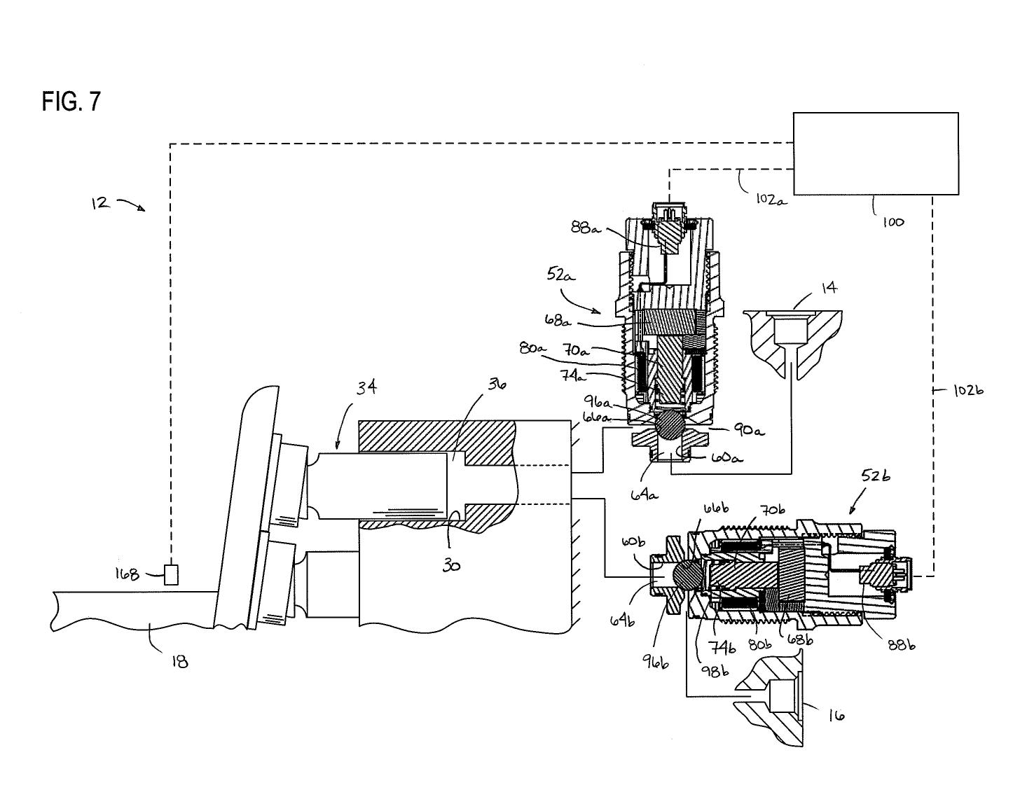

In the depicted embodiment of FIG. 7, the second end 64a of the cavity 60a of the first latch valve 52a is in fluid communication with the fluid inlet 14 while the passage 90a of the first latch valve 52a is in fluid communication with the cylinder bore 30 of the fluid device 12. In this configuration, when the pressure of the fluid at the fluid inlet 14 is greater than the pressure of the fluid in the cylinder bore 30, the check ball 96a lifts off the valve seat 66a toward the second end portion 74a of the magnetic pole 70a so that fluid can be communicated between the fluid inlet 14 and the cylinder bore 30. When the pressure of the fluid at the cylinder bore 30 is greater than the pressure of the fluid at the fluid inlet 14 and when the check ball 96a is released from the second end portion 74a of the magnetic pole 70a, the check ball 96a abuts the valve seat 66a so that fluid communication is blocked between the fluid inlet 14 and the cylinder bore 30.

In the depicted embodiment of FIG. 7, the second end 64b of the cavity 60b of the second latch valve 52b is in fluid communication with the cylinder bore 30 of the fluid device 12 while the passage 90b of the second latch valve 52b is in fluid communication with the fluid outlet 16. In this configuration, when the pressure of the fluid at the cylinder bore 30 is greater than the pressure of the fluid at the fluid outlet 16, the check ball 96b lifts off the valve seat 66b toward the second end portion 74b of the magnetic pole 70b so that fluid can be communicated between the cylinder bore 30 and the fluid outlet 16. When the pressure of the fluid at the cylinder bore 30 is greater than the pressure of the fluid at the fluid outlet 16 and when the check ball 96b is released from the second end portion 74b of the magnetic pole 70b, the check ball 96b abuts the valve seat 66b so that fluid communication is blocked between the cylinder bore 30 and the fluid outlet 16.

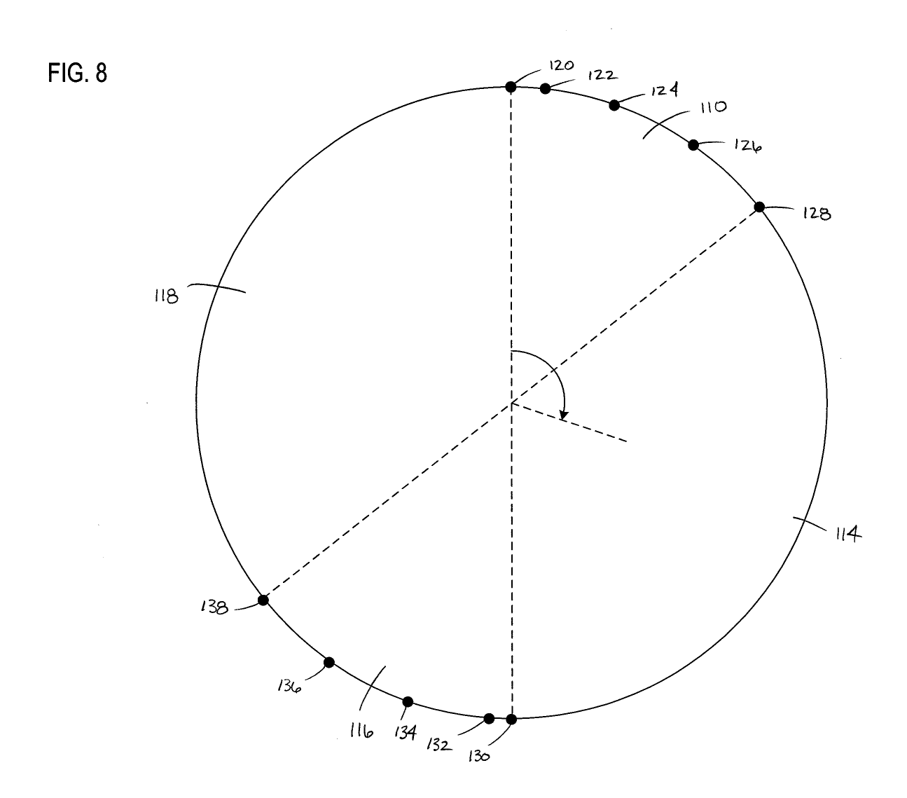

In FIG. 8, an operational diagram of one of the plurality of pistons 34 in one of the plurality of cylinder bores 30 of the fluid device 12 is shown when the fluid device 12 is in the pumping mode. The operational diagram of FIG. 8 is shown as a circle to represent a filling/emptying cycle of the volume chamber 36. In the depicted embodiment, the circle also represents a complete rotation of the shaft 18. The filling/emptying cycle of the volume chamber 36 includes a first pressure transition portion 110, an inlet portion 112, a second pressure transition portion 114 and an outlet portion 116.

In the depicted embodiment, fluid pressure in the volume chamber 36 decreases from a first fluid pressure that is generally similar to the fluid pressure at the fluid outlet 16 to a second fluid pressure that is generally similar to the fluid pressure at the fluid inlet 14 during the first pressure transition portion 110 of the filling/emptying cycle of the volume chamber 36. By allowing the pressure in the volume chamber 36 to gradually decrease, noise corresponding to the valving arrangement is reduced since there is not a large pressure differential between the fluid pressure in the volume chamber 36 and the fluid pressure at the fluid inlet 14.

The first pressure transition portion 110 of the filling/emptying cycle of the volume chamber 36 includes a point 120 in which the piston 34 is fully retracted in the cylinder bore 30. When the piston 34 is fully retracted, the volume chamber 36 is fully contracted.

At the fully contracted state (i.e., point 120), the first latch valve 52a is in the closed position while the second latch valve 52b is in the open position. At point 120, the second latch valve 52b is held in the open position by the permanent magnet 68b so that the check ball 96b is magnetically held to the second end portion 74b of the magnetic pole 70b. When the volume chamber 36 is fully contracted, there is a residual amount of fluid in the volume chamber 36 that does not get expelled through the second latch valve 54b. This residual fluid has a fluid pressure that is generally equal to the fluid pressure of fluid at the fluid outlet 16.

As the shaft 18 rotates, the electronic signal 102b is sent to the coil 80b through the connector 88b so that the coil 80b generates the magnetic field that opposes the magnetic field of the permanent magnet 68b of the second latch valve 52b. With the magnetic field of the coil 80b opposing the magnetic field of the permanent magnet 68b, the check ball 96b is delatched from the second end portion 74b of the magnetic pole 70b of the second latch valve 52b at point 122. The point 122 follows point 120. In the depicted embodiment, the point 122 is immediately adjacent to the point 120.

At point 124, the piston 34 is being extended from the cylinder bore 30 by the fluid pressure of the residual fluid in the volume chamber 36. As the piston 34 is extended, the fluid pressure of the residual fluid in the volume chamber 36 decreases. As the volume chamber 36 is in fluid communication with the second end 64b of the cavity 60b, the decrease in fluid pressure causes the fluid pressure from the fluid at the fluid outlet 16 and the spring 98b move the check ball 96b so that the check ball 96b abuts the valve seat 66b of the second latch valve 52b.

During the first pressure transition portion 110 of the filling/emptying cycle of the volume chamber 36, both the first and second latch valves 52a, 52b are in the closed position for a duration of time during which the piston 34 is being extended from the cylinder bore 30. With the first and second latch valves 52a, 52b in the closed position, the pressure in the volume chamber 36 continues to decrease as the piston 34 is extended from the cylinder bore 30 as the shaft 18 rotates. At point 126, the fluid pressure in the volume chamber 36 drops slightly below the fluid pressure of the fluid at the fluid inlet 14. At point 126, the check ball 96a of the first latch valve 52a begins to lift off of the valve seat 66a.

During the inlet portion 112 of the filling/emptying cycle of the volume chamber 36, the volume chamber 36 is adapted to receive fluid from the fluid inlet 14. The inlet portion 112 includes point 128. At point 128, the fluid pressure from the fluid at the fluid inlet 14 moves the check ball 96a to the open position. The check ball 96a abuts the second end portion 74a of the magnetic pole 70a of the first latch valve 52a. The check ball 96a is held in the open position by the permanent magnet 68a regardless of the fluid pressure in the volume chamber 36 or the fluid inlet 14.

When the piston 34 is adjacent to the location at which the piston 34 is at the fully extended state, the electronic signal 102a is sent to the coil 80a through the connector 88a so that the coil 80a generates the magnetic field that opposes the magnetic field of the permanent magnet 68a of the first latch valve 52a. With the magnetic field of the coil 80a opposing the magnetic field of the permanent magnet 68a, the check ball 96a is delatched from the second end portion 74a of the magnetic pole 70a of the first latch valve 52a at point 130.

In the depicted embodiment, the delatching of the first valve 52a at point 130 begins the second pressure transition portion 116 of the filling/emptying cycle of the volume chamber 36. During the second pressure transition portion 116, fluid pressure of the fluid in the volume chamber 36 increases from a fluid pressure that is generally similar to the fluid inlet 14 to a fluid pressure that is generally similar to the fluid outlet 16. By allowing the pressure in the volume chamber 36 to gradually increase, noise corresponding to the valving arrangement is reduced since there is not a large pressure differential between the fluid pressure in the volume chamber 36 and the fluid pressure at the fluid outlet 16.

At point 132, the piston 34 is fully extended from cylinder bore 30. While the point 132 is shown after point 130, it will be understood that point 132 can precede point 130.

As the piston 34 retracts in the cylinder bore 30, fluid pressure in the volume chamber 36 increases. As the fluid pressure in the volume chamber 36 increases, the fluid pressure and force of the spring 98a move the check ball 96a of the first latch valve 52a to the closed position so that the check ball 96a abuts the valve seat 66a at point 134.

During the second pressure transition portion 116 of the filling/emptying cycle of the volume chamber 36, both the first and second latch valves 52a, 52b are in the closed position for a duration of time during which the piston 34 is being retracted in the cylinder bore 30. With the first and second latch valves 52a, 52b in the closed positions, the fluid pressure in the volume chamber 36 increases as the piston 34 retracts in the cylinder bore 30. The fluid pressure in the volume chamber 36 acts on the check ball 96b of the second latch valve 52b. When the fluid pressure increases to a value that is above the fluid pressure of fluid at the fluid outlet 16 and the force of the spring 98b of the second latch valve 52b acting on the check ball 96b, the check ball 96b lifts off of the valve seat 66b at point 136.

As the fluid pressure increases in the volume chamber 36, the fluid pressure moves the check ball 96b so that the check ball 96b abuts the second end portion 74b of the magnetic pole 70b. The permanent magnet 68b of the second latch valve 52b holds the check ball 96b in this open position.

With the second latch valve 52b in the open position, the filling/emptying cycle of the volume chamber 36 begins the output portion 118. During the output portion 118, fluid in the volume chamber 36 is communicated to the fluid outlet 16. The output portion 118 continues until the piston 34 is fully retracted in the cylinder bore 30.

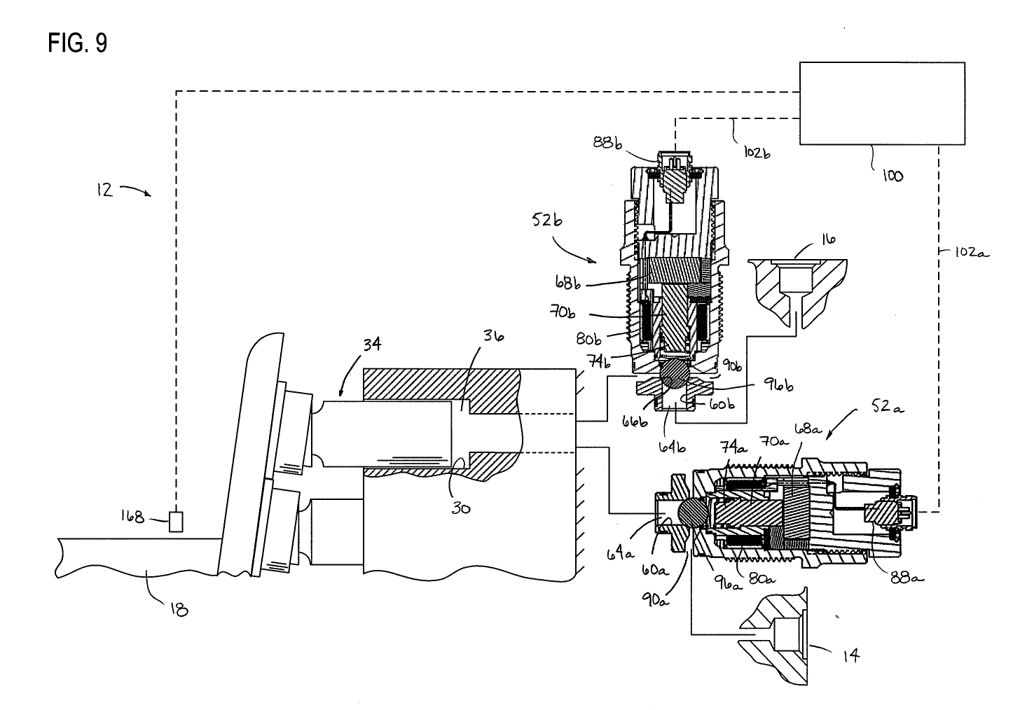

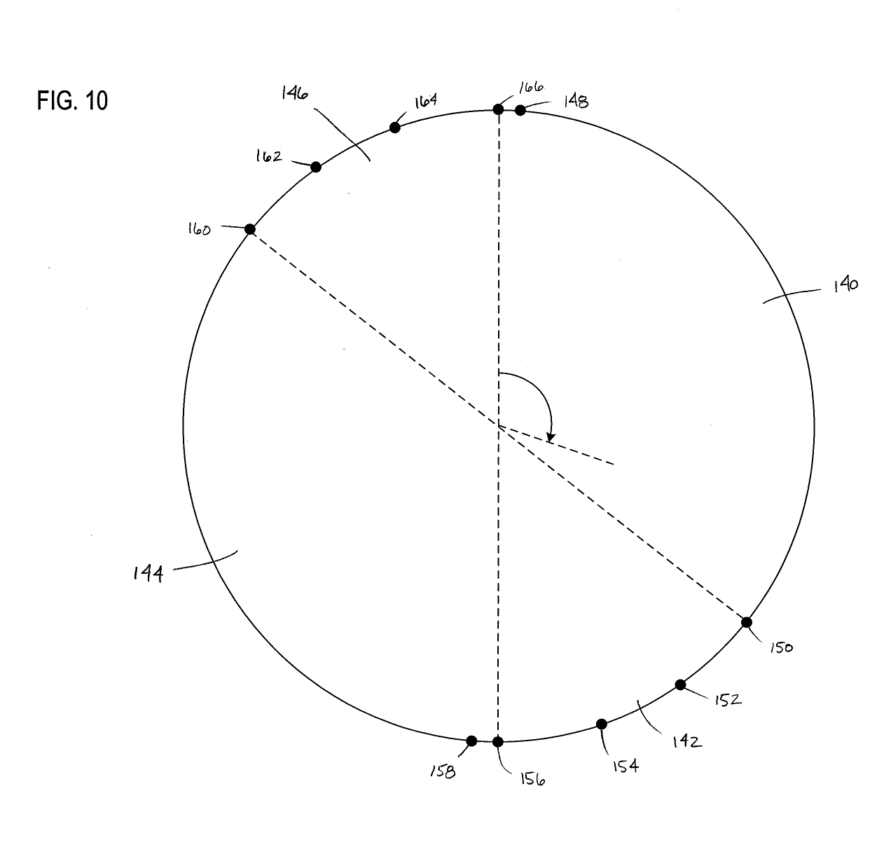

Referring now to FIGS. 9 and 10, the motoring mode of the fluid device 12 will be described. FIG. 10 provides an operational diagram of one of the plurality of pistons 34 in one of the plurality of cylinder bores 30 of the fluid device 12 when the fluid device 12 is in the motoring mode. The operational diagram of FIG. 10 is shown as a circle to represent a filling/emptying cycle of the volume chamber 36. The filling/emptying cycle of the volume chamber 36 includes a power portion 140, a first pressure transition portion 142, an exhaust portion 144 and a second pressure transition portion 146.

In the motoring mode, pressurized fluid enters the volume chamber 36 so that the piston 34 is extended from the cylinder bore 30. The extension of the piston 34 from the cylinder bore 30 causes the shaft 18 to rotate. In the motoring mode, fluid at the fluid inlet 14 of the fluid device 12 is at a high pressure than fluid at the fluid outlet 16. Typically, the fluid inlet 14 is in fluid communication with the pump 24 (shown in FIG. 2) while fluid at the fluid outlet 16 is in fluid communication with the fluid reservoir 20.

In the depicted embodiment of FIG. 9, the second end 64a of the cavity 60a of the first latch valve 52a is in fluid communication with the cylinder bore 30 of the fluid device 12 while the passage 90a of the first latch valve 52a is in fluid communication with the fluid inlet 14. In this configuration, when the pressure of the fluid at the cylinder bore 30 is greater than the pressure of the fluid at the fluid inlet 14, the check ball 96a lifts off the valve seat 66a toward the second end portion 74a of the magnetic pole 70a so that fluid can be communicated between the cylinder bore 30 and the fluid inlet 14. When the pressure of the fluid at the cylinder bore 30 is greater than the pressure of the fluid at the fluid outlet 16 and when the check ball 96 is released from the second end portion 74 of the magnetic pole 70, the check ball 96 abuts the valve seat 66 so that fluid communication is blocked between the cylinder bore 30 and the fluid outlet 16.

In the depicted embodiment of FIG. 9, the second end 64a of the cavity 60a of the first latch valve 52a is in fluid communication with the cylinder bore 30 of the fluid device 12 while the passage 90a of the first latch valve 52a is in fluid communication with the fluid inlet 14. The second end 64b of the cavity 60b of the second latch valve 52b is in fluid communication with the fluid outlet 16 while the passage 90b of the second latch valve 52b is in fluid communication with the cylinder bore 30 of the fluid device 12.

At point 148 of the filling/emptying cycle, the piston 34 is fully retracted in the cylinder bore 30. At this point, the check ball 96a of the first latch valve 52a is magnetically held to the second end portion 74a of the magnetic pole 70a so that fluid from the fluid inlet 14 is in communication with the volume chamber 36 while the second latch valve 52b is in the closed position. As fluid from the fluid inlet enters the volume chamber 36, the piston 34 extends from the cylinder bore 30. In the depicted embodiment, the extension of the piston 34 causes the shaft 18 to rotate.

At point 150, the electronic signal 102a is sent to the coil 80a of the first latch valve 52a. The coil 80a generates a magnetic field that opposes the magnetic field of the permanent magnet 68a, which delatches the check ball 96a from the magnetic pole 70a.

At point 152, fluid pressure in the volume chamber 36 decreases as the piston 34 extends from the cylinder bore 30. As the fluid pressure in the volume chamber 36 decreases, the fluid pressure at the fluid inlet 14 causes the check ball 96a of the first latch valve 52a to abut the valve seat 66a.

At point 154, the fluid pressure in the volume chamber 36 continues to decrease as the piston 34 extends from the cylinder bore 30. When the fluid pressure drops below the fluid pressure at the fluid outlet 16, the check ball 96b of the second latch valve 52b lifts off of the valve seat 66b. The check ball 96b abuts the second end portion 74b of the magnetic pole 70b at point 156. At point 158, the piston 34 is in the fully extended position in the cylinder bore 30.

With the check ball 96b of the second latch valve 52b held in the open position by the permanent magnet 68b, the volume chamber 36 is now in the exhaust portion of the filling/emptying cycle. During the exhaust portion of the filling/emptying cycle, fluid in the volume chamber 36 is expelled to the fluid outlet 16.

At point 160, the electronic signal 102b is sent to the coil 80b of the second latch valve 52b. The coil 80b generates a magnetic field that opposes the magnetic field of the permanent magnet 68b, which causes the check ball 96b to be released from the magnetic pole 70b. The release of the check ball 96b from the magnetic pole 70b begins the second pressure transition portion of the filling/emptying cycle of the volume chamber 36. During the second pressure transition portion of the filling/emptying cycle of the volume chamber 36, the fluid pressure in the volume chamber 36 increases.

At point 162, fluid pressure in the volume chamber 36 increases so that the check ball 96b of the second latch valve 52b abuts the valve seat 66b. With the first and second latch valves 52a, 52b in the closed position, fluid pressure in the volume chamber 36 increases as the piston 34 retracts in the cylinder bore 36.

At point 164, the fluid pressure in the volume chamber 36 increases so that the check ball 96a of the first latch valve 52a lifts off of the valve seat 66a. The fluid pressure in the volume chamber 36 continues to increase until the check ball 96a is magnetically held to the magnetic pole 70a of the first latch valve at point 166.

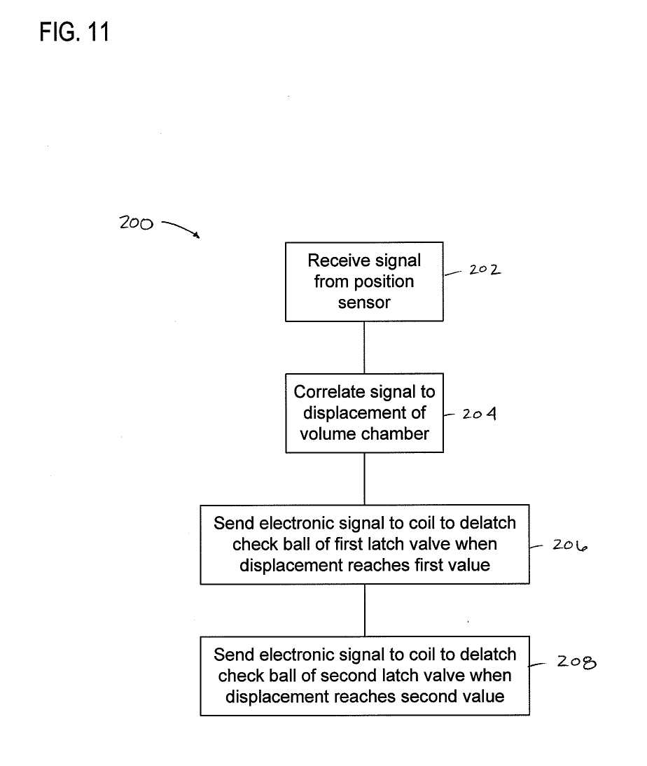

Referring now to FIGS. 7 and 11, a method 200 for valving the fluid device 12 will be described. The controller 100 of the fluid device 12 receives a signal from a position sensor 168 in step 202. In the depicted embodiment, the position sensor 166 provides information related to the angular position of the shaft 18 to the controller 100.

In one embodiment, the controller 100 correlates the signal to a displacement of each of the volume chambers 36 of the displacement assembly 26 in step 204. In one embodiment, the displacement is the angular position of the displacement assembly 26. In another embodiment, the displacement is the axial position of the pistons 34 in the cylinder bores 30.

Fluid pressure in the volume chamber 36 causes the check ball 96a of the first latch valve 52a to unseat from the valve seat 66a and to abut the second end portion 74a of the magnetic pole 70a. The permanent magnet 68a holds the check ball 96a against the second end portion 74a of the magnetic pole 70a.

When the displacement of each of the volume chambers 36 reaches a first value, the controller 100 send the electronic signal 102a to the first latch valve 52a so that the check ball 96a is magnetically delatched from the magnetic pole 70a of the first latch valve 52a in step 206. Alternatively, the signal from the position sensor 168 can be directly compared to a first value so that when the signal reaches the first value, the controller 100 sends the electronic signal 102a to the first latch valve 52a. In one embodiment, the electronic signal 102a is a pulse having a duration that is a fraction of the time in which the shaft 18 makes a complete rotation so that the duration of the pulse is less than the time in which the shaft 18 makes a complete rotation.

With the check ball 96a delatched from the magnetic pole 70a, fluid pressure seats the check ball 96a of the first latch valve 52a against the valve seat 66a of the first latch valve 52a. In the depicted embodiment, the spring 98a biases the check ball 96a to the seated position. With the first latch valve 52a in the closed position, fluid pressure in the volume chamber 36 causes the second latch valve 52b to open so that the check ball 96b is lifted off of (i.e., unseated from) the valve seat 66b.

When the displacement of each of the volume chambers 36 reaches a second value, the controller 100 send the electronic signal 102b to the second latch valve 52b so that the check ball 96b is magnetically delatched from the magnetic pole 70b of the second latch valve 52b in step 208. Alternatively, the signal from the position sensor 168 can be directly compared to a second value so that when the signal reaches the second value, the controller 100 sends the electronic signal 102b to the second latch valve 52b. In one embodiment, the electronic signal 102b is a pulse having a duration that is a fraction of the time in which the shaft 18 makes a complete rotation so that the duration of the pulse is less than the time in which the shaft 18 makes a complete rotation.

With the check ball 96b delatched from the magnetic pole 70b, fluid pressure seats the check ball 96b of the second latch valve 52b against the valve seat 66b of the second latch valve 52b. In the depicted embodiment, the spring 98b biases the check ball 96b to the seated position. With the second latch valve 52b in the closed position, fluid pressure in the volume chamber 36 causes the first latch valve 52a to open so that the check ball 96a is lifted off of (i.e., unseated from) the valve seat 66a.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A method of valving a fluid device, the method comprising:
receiving a signal;
correlating the signal to a displacement of a volume chamber of a displacement assembly of a fluid device;
delatching a check ball from a magnetic pole of a first latch valve in fluid communication with the volume chamber and a fluid inlet of the fluid device when the displacement of the volume chamber reaches a first value;
delatching a check ball from a magnetic pole of a second latch valve in fluid communication with the volume chamber and a fluid outlet of the fluid device when the displacement of the volume chamber reaches a second value.

2. The method of claim 1, wherein fluid pressure seats the check ball of the first latch valve against a valve seat of the first latch valve after the check ball of the first latch valve is delatched.

3. The method of claim 2, wherein fluid pressure unseats the check ball of the second latch valve from a valve seat of the second latch valve after the check ball of the first latch valve is seated.

4. The method of claim 1, wherein the signal is provided by a position sensor.

5. The method of claim 4, wherein the position sensor monitors the angular position of a shaft of the fluid device.

6. The method of claim 1, wherein the displacement assembly is an axial piston assembly.

7. The method of claim 1, wherein each of the first and second latch valves includes:
a body defining a cavity having the valve seat;
a coil disposed in the cavity;
a permanent magnet disposed in the cavity;
the magnetic pole having a first end portion and an oppositely disposed second end portion, the first end portion being adjacent to the permanent magnet; and
the check ball disposed in the cavity between the second end portion of the magnetic pole and the valve seat.

8. The method of claim 7, wherein an electronic pulse is transmitted to the coil of the first latch valve to generate a magnetic field that opposes the magnetic field of the permanent magnet to delatch the check ball.

9. A method of valving a fluid device, the method comprising:
receiving a signal from a position sensor;
transmitting an electronic pulse to a coil of a first latch valve when the signal reaches a first value, the first latch valve being in fluid communication with a fluid inlet and a volume chamber defined by a piston and a cylinder bore, wherein the electronic pulse delatches a check ball from a magnetic pole of the first latch valve; and
transmitting an electronic pulse to a coil of a second latch valve when the signal reaches a second value, the second latch valve being in fluid communication with a fluid outlet and the volume chamber, wherein the electronic pulse delatches a check ball from a magnetic pole of the second latch valve.

10. The method of claim 9, wherein fluid pressure seats the check ball of the first latch valve against a valve seat of the first latch valve after the check ball of the first latch valve is delatched.

11. The method of claim 10, wherein fluid pressure unseats the check ball of the second latch valve from a valve seat of the second latch valve after the check ball of the first latch valve is seated.

12. The method of claim 9, wherein the position sensor monitors the angular position of a shaft of the fluid device.

13. The method of claim 9, wherein each of the first and second latch valves includes:
a body defining a cavity having the valve seat;
the coil disposed in the cavity;
a permanent magnet disposed in the cavity;
the magnetic pole having a first end portion and an oppositely disposed second end portion, the first end portion being adjacent to the permanent magnet; and
the check ball disposed in the cavity between the second end portion of the magnetic pole and the valve seat.

14. A fluid device comprising:
a housing defining a fluid inlet and a fluid outlet;
a displacement assembly in fluid communication with the fluid inlet and the fluid outlet, the displacement assembly defining a plurality of volume chambers;
a plurality of first magnetic latch valves in fluid communication with the fluid inlet and the plurality of volume chambers;
a plurality of second magnetic latch valves in fluid communication with the fluid outlet and the plurality of volume chambers;
each of the first and second magnetic latch valves including:
a body defining a cavity having a valve seat;
a coil disposed in the cavity;
a permanent magnet disposed in the cavity;
a magnetic pole having a first end portion and an oppositely disposed second end portion, the first end portion being adjacent to the permanent magnet; and
a check ball disposed in the cavity between the second end portion of the magnetic pole and the valve seat.

15. The fluid device of claim 14, further comprising a shaft engaged to the displacement assembly.

16. The fluid device of claim 15, further comprising a position sensor for monitoring the rotational position of the shaft.

17. The fluid device of claim 14, wherein the displacement assembly is an axial piston assembly, the axial piston assembly including:
a cylinder barrel defining a plurality of cylinder bores;
a plurality of pistons disposed in the plurality of cylinder bores, wherein the plurality of pistons and the plurality of cylinder bores cooperatively define the plurality of volume chambers; and
a swashplate in sliding engagement with the plurality of pistons.

18. The fluid device of claim 17, wherein the cylinder barrel is rotationally stationary.

19. The fluid device of claim 18, wherein a shaft is engaged to the swashplate of the axial piston assembly.

20. The fluid device of claim 17, wherein the cylinder barrel defines less than or equal to twelve cylinder bores.
